(19) United States
(12) Patent Application Publication
(10) Pub. No.: US 2014/0369469 A1
(43) Pub. Date: Dec. 18, 2014

(54) X-RAY GENERATION APPARATUS AND X-RAY RADIOGRAPHIC APPARATUS

(71) Applicants: Takao Ogura, Yokohama-shi (JP); Miki Tamura, Kawasaki-shi (JP); Yasue Sato, Machida-shi (JP); Tamayo Hiroki, Zama-shi (JP)

(72) Inventors: Takao Ogura, Yokohama-shi (JP); Miki Tamura, Kawasaki-shi (JP); Yasue Sato, Machida-shi (JP); Tamayo Hiroki, Zama-shi (JP)

(73) Assignee: CANON KABUSHIKI KAISHA, Tokyo (JP)

(21) Appl. No.: 14/241,401

(22) PCT Filed: Aug. 29, 2012
(86) PCT No.: PCT/JP2012/072514

§ 371 Date: Feb. 26, 2014

(30) Foreign Application Priority Data
Aug. 31, 2011 (JP) 2011-189223

(51) Int. Cl. H01J 35/08; H01J 35/16; G01N 23/04

(52) U.S. Cl. CPC H01J 35/08; G01N 23/04; H01J 35/16; H01J 2235/087; H01J 2235/186; H01J 2235/081
USPC 378/62; 378/121

(57) ABSTRACT

In an X-ray generation apparatus of transmission type including an electron passage surrounded by and formed in an electron passage forming member, and generating an X-ray by colliding electrons having passed through the electron passage against a target, wherein the electron passage includes a secondary X-ray generation portion that generates an X-ray with collision of electrons reflected by the target against the secondary X-ray generation portion, the secondary X-ray generation portion and the target are arranged such that the X-ray generated with direct collision of the electrons against the target and the X-ray generated with the collision of the electrons reflected by the target against the secondary X-ray generation portion are both radiated to an outside, and an atomic number of a material of the electron passage forming member is larger than that of the target. X-ray generation efficiency is increased by effectively utilizing the electrons reflected by the target.

### TECHNICAL FIELD

The present invention relates to an X-ray generation apparatus, which can be applied to, e.g., nondestructive X-ray radiography used in the fields of medical equipment and industrial equipment, and also relates to an X-ray radiographic apparatus employing the X-ray generation apparatus.

### BACKGROUND ART

An X-ray generation apparatus of the type generating an X-ray by colliding (bombarding) electrons against a transmission-type target is suitable for reducing the apparatus size, but X-ray generation efficiency is very low. The reason is that, when electrons are accelerated to a high energy level and are collided against the transmission-type target to generate an X-ray, about 1% or less of energy of the colliding electrons is converted to the X-ray and the rest, i.e., about 99% or more, is converted to heat. Therefore, an improvement of the X-ray generation efficiency is demanded.

PTL 1 discloses an X-ray tube in which the X-ray generation efficiency is increased by arranging, between an electron source and a target, an anode member having a conical channel with its aperture diameter gradually narrowing toward the target from the electron source, and by introducing electrons to impinge against the target after being subjected to elastic scattering at a channel surface.

### CITATION LIST

### Patent Literature

PTL 1 Japanese Patent Laid-Open No. 9-171788

### SUMMARY OF INVENTION

### Technical Problem

In the related-art X-ray generation apparatus, reflection electrons are produced upon the electrons colliding against the transmission-type target, but most of the reflection electrons do not contribute to the generation of the X-ray. Accordingly, the X-ray generation efficiency with respect to input power is not sufficient.

The present invention provides a transmission-type X-ray generation apparatus capable of increasing the X-ray generation efficiency by effectively utilizing electrons that are reflected by a transmission-type target.

### Solution to Problem

According to the present invention, there is provided an X-ray generation apparatus of transmission type including an electron passage surrounded by and formed in an electron passage forming member, and generating an X-ray by colliding electrons having passed through the electron passage against a target, wherein the electron passage includes a secondary X-ray generation portion that generates an X-ray with collision of electrons reflected by the target against the secondary X-ray generation portion, the secondary X-ray generation portion and the target are arranged such that the X-ray generated with direct collision of the electrons against the target and the X-ray generated with the collision of the electrons reflected by the target against the secondary X-ray generation portion are both radiated to an outside, and an atomic number of a material of the electron passage forming member is larger than an atomic number of a material of the target.

### Advantageous Effects of Invention

With the present invention, in addition to the X-ray generated from the transmission-type target, the X-ray generated by the reflection electrons produced from the transmission-type target can also be efficiently taken out to the outside. As a result, the X-ray generation efficiency can be increased.

### BRIEF DESCRIPTION OF DRAWINGS

FIG. 1 is a schematic view of an X-ray tube used in the present invention.

FIGS. 2A and 2B are schematic views of a target unit used in the present invention.

FIG. 3 is a schematic view of an anode used in the present invention.

FIG. 4 is a schematic view of another anode used in the present invention.

FIG. 5 is a schematic view illustrating a modification of still another anode used in the present invention.

FIGS. 6A and 6B are schematic views of still another anode used in the present invention.

FIGS. 7A and 7B are schematic views illustrating a modification of the target unit used in the present invention.

FIGS. 8A and 8B are block diagrams illustrating respectively an X-ray generation apparatus and an X-ray radiographic apparatus according to the present invention.

### DESCRIPTION OF EMBODIMENTS

Embodiments of the present invention will be described below with reference to the drawings. It is to be noted that a transmission-type X-ray generation apparatus (hereinafter referred to as an “X-ray generation apparatus”) according to the present invention can be similarly applied to an apparatus for generating other radiations, such as a neutron beam.

### First Embodiment

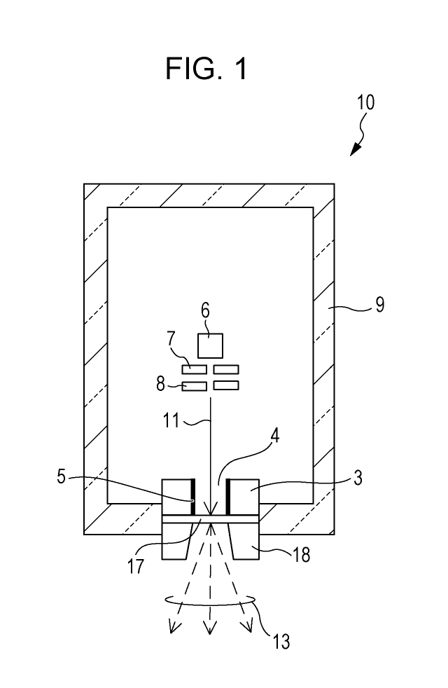

FIG. 1 is a schematic view of a transmission-type X-ray generation tube (hereinafter referred to simply as an “X-ray tube”) used in the X-ray generation apparatus according to a first embodiment. In the X-ray generation apparatus, an X-ray tube 10 illustrated in FIG. 1 is disposed in an envelope having a window through which an X-ray is taken out, as described later.

A vacuum vessel 9 is to keep the inside of the X-ray tube 10 vacuum and is made of, e.g., glass or ceramic materials. A degree of vacuum within the vacuum vessel 9 is kept at about 10⁻⁴ to 10⁻⁸ Pa. The vacuum vessel 9 has an opening, and an electron passage forming member 3 including an electron passage 4 formed therein is joined to the opening. A target unit 17 is joined to an end surface of the electron passage forming member 3, whereby the vacuum vessel 9 is enclosed. Further, an evacuation pipe (not illustrated) may be mounted to the vacuum vessel 9. When the evacuation pipe is mounted, the inside of the vacuum vessel 9 can be made vacuum, for example, by evacuating the vacuum vessel 9 into a vacuum state through the evacuation pipe and then sealing off a part of the evacuation pipe. A getter (not illustrated) may be disposed within the vacuum vessel 9 to keep the vacuum.

An electron emission source 6 is disposed within the vacuum vessel 9 in opposed relation to a transmission-type target 1 (hereinafter referred to simply as a “target 1”), which is a constituent member of the target unit 17. The electron passage forming member 3 is disposed between the target 1 and the electron emission source 6, and the electron passage 4 is formed in such a state that the electron passage 4 is surrounded by the electron passage forming member 3 and is opened at both ends thereof. The electron emission source 6 can be made of, e.g., a hot cathode, such as a tungsten filament or an impregnated cathode, or a cold cathode, such as a carbon nanotube. An electron beam 11 emitted from the electron emission source 6 enters the electron passage 4, which is formed by the electron passage forming member 3, from one end thereof. After passing through the electron passage 4, the electron beam 11 collide (bombards) against the target 1 that is disposed on the other end side of the electron passage 4. Upon the electron beam 11 colliding against the target 1, an X-ray 13 is generated and the generated X-ray 13 is taken out to the outside of the vacuum vessel 9. The X-ray tube 10 may include an extraction electrode 7 and a focusing electrode 8. In such a case, electrons are expelled out from the electron emission source 6 by the action of an electric field formed by the extraction electrode 7, and the extracted electrons are focused by the focusing electrode 8 so as to impinge against the target 1. A voltage Va applied between the electron emission source 6 and the target 1 at that time is about 40 kV to 150 kV though depending on uses of the X-ray.

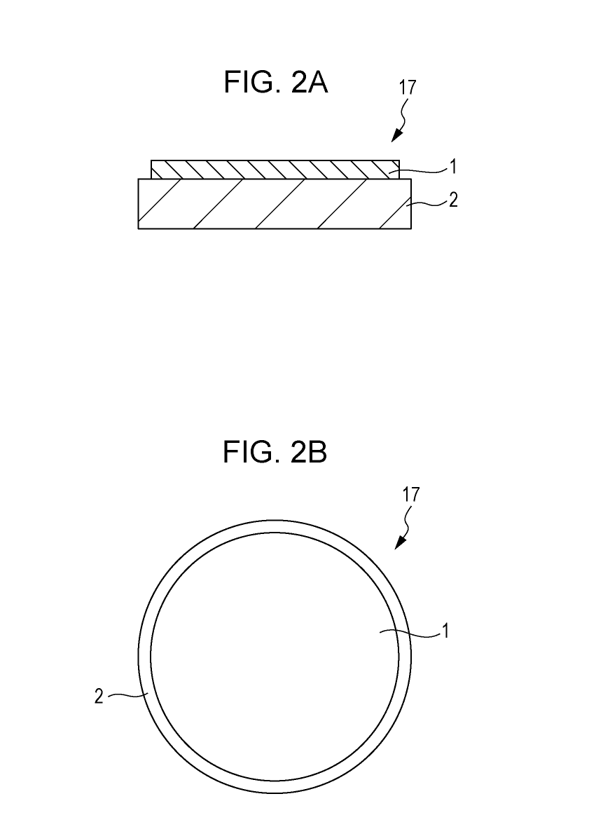

FIGS. 2A and 2B are schematic views of the target unit 17. FIG. 2A is a sectional view, and FIG. 2B is a plan view when viewed from the side closer to the electron emission source 6 in FIG. 1. The target unit 17 is made up of the target 1 and a support base 2 that further serves as an X-ray transmission window.

The target 1 is disposed on a surface of the support base 2 on the side colder to the electron emission source 6. While the shape of the target 1 illustrated in the plan view of FIG. 2B is circular, it may be rectangular.

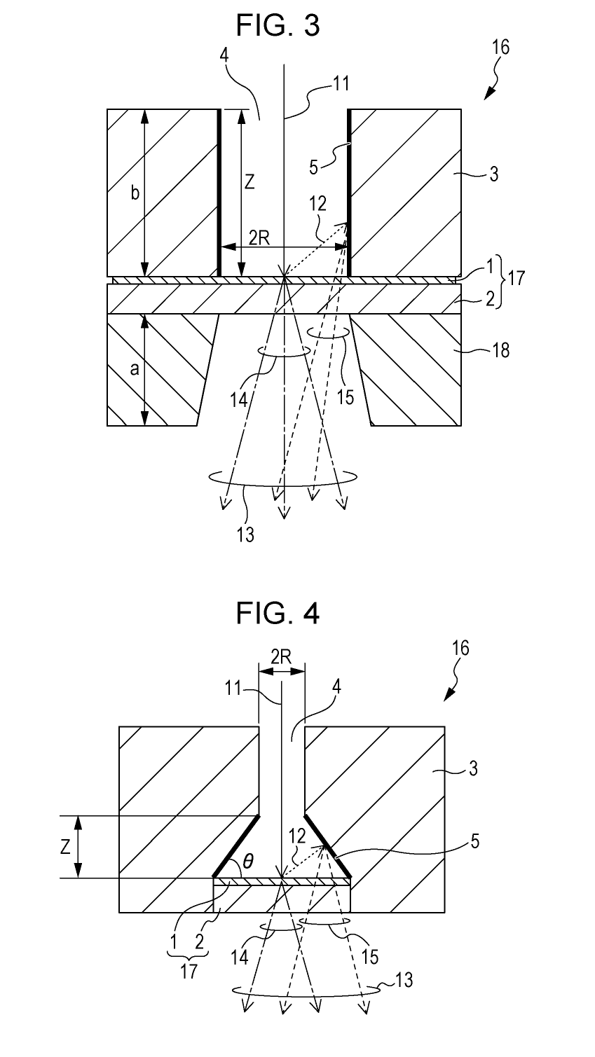

FIG. 3 is a sectional view of an anode 16. The anode 16 is made up of the target unit 17, the electron passage forming member 3 including the electron passage 4, and a shield member 18.

The target 1 is electrically conducted to the electron passage forming member 3. A secondary X-ray generation portion 5 is formed in the electron passage forming member 3. In FIG. 3, an inner wall surface of the electron passage 4 serves as the secondary X-ray generation portion 5. Because the secondary X-ray generation portion 5 is of the planar form in this embodiment, it may be called the “secondary X-ray generation surface 5” in some cases. The secondary X-ray generation portion (surface) 5 may be formed as a part of the inner wall surface of the electron passage 4, or may be formed on the inner wall surface of the electron passage 4 by using a separate member from the electron passage forming member 3.

The joining between the shield member 18 and the target unit 17 and the joining between the target unit 17 and the electron passage forming member 3 may be performed by, e.g., brazing, mechanical pressing, or screwing.

In the X-ray tube 10 thus constructed, the electrons (electron beam) 11 expelled out from the electron emission source 6 are accelerated to collide against the target 1 after passing through the electron passage 4, whereupon an X-ray 14 is generated. The X-ray 14 generated at that time transmits through the support base 2 and is radiated to the outside of the X-ray tube 10. Further, when the electrons collide against the target 1, reflection electrons 12 are produced in addition to the generation of the X-ray 14. Because the target 1 is generally made of a metal having a large atomic number, reflectivity of electrons at the target 1 is comparatively large, i.e., 20% to 60%. The reflection electrons 12 produced from the target 1 collide against the secondary X-ray generation portion 5, thereby generating an X-ray 15. The X-ray 15 (hereinafter referred to as the “secondary X-ray”) generated at that time is also radiated to the outside of the X-ray tube 10 after transmitting through the support base 2. Stated another way, at least a part of the secondary X-ray 15 generated upon the reflection electrons 12 colliding against the secondary X-ray generation portion 5 and the X-ray 14 generated upon the electrons colliding against the target 1 are both radiated to the outside of the X-ray tube 10 after transmitting through the support base 2.

The target 1 is usually made of a metal material having an atomic number of 26 or more. The metal material can have a higher thermal conductivity and a greater specific heat. Further, a film thickness of the target 1 is to be set such that the generated X-rays transmit through the target 1. Although a maximum value of the thickness of the target 1 varies because an X-ray generation region, i.e., a penetration depth of the electron beam, differs depending on an acceleration voltage, it is usually 1 μm to 15 μm. The support base 2 may be made of diamond, for example, and its appropriate thickness is 0.5 mm to 5 mm.

The shield member 18 has an X-ray passage that is opened at both ends thereof to allow passage of the X-ray therethrough. The target unit 17 is joined to one end surface of the shield member 18. The shield member 18 has the function of taking out a necessary part of the X-ray radiated forward (i.e., in a direction opposed to the electron emission source 6 with respect to the target 1) through an opening thereof, while intercepting an unnecessary part of the X-ray. The shield member 18 may be made of any material capable of intercepting an X-ray that is generated at 40 kV to 150 kV. The material of the shield member 18 can have a higher X-ray absorption rate and a higher thermal conductivity. When the target 1 is made of tungsten, the shield member 18 is preferably made of, e.g., tungsten, tantalum, or an alloy material using any one of the formers. When the target 1 is made of molybdenum, the shield member 18 may be made of not only tungsten or tantalum, but also molybdenum, zirconium, or niobium, for example.

A shape of the opening of the shield member 18 may be circular or rectangular. A size of the opening of the shield member 18 is to be set such that at least the necessary X-ray can be taken out through the opening. When the shape of the opening of the shield member 18 is circular, a diameter of the opening is preferably 0.1 mm to 3 mm. When the shape of the opening of the shield member 18 is rectangular, one side of a rectangle is preferably 0.1 mm to 3 mm. The reason is that if the opening size is smaller than 0.1 mm, an X-ray amount would be too small to satisfactorily execute a radiographic operation in practical use, and that if the opening size is larger than 3 mm, a heat dissipation effect through the shield member 18 would be difficult to obtain.

Moreover, the opening of the shield member 18 can be gradually widened forward. In other words, the opening of the shield member 18 can be gradually widened from the opening end of the shield member 18 on the side closer to the target 1 toward the opening end of the shield member 18 on the side farther away from the target 1. The reason is that when the target-side opening end of the shield member 18 is narrow, heat generated from the target 1 can be quickly conducted to the shield member 18 for dissipation, and that when the opening end of the shield member 18 on the side farther away from the target 1 is wide, an X-ray irradiation region in the radiographic operation can be increased.

A thickness a of the shield member 18 may be optionally set on condition that a shield effect of reducing the generated X-ray to such a level as causing substantially no problems is obtained at the set thickness. The thickness a of the shield member 18 differs depending on energy of the generated X-ray. For example, when the energy of the X-ray is 30 keV to 150 keV, the thickness a of the shield member 18 requires to be at least 1 mm to 3 mm even when tungsten having a relatively great shield effect is used. From the viewpoint of intercepting the X-ray, there are no problems when the thickness a of the shield member 18 is not larger than the above-mentioned range of value. However, it is more preferably to be 3 mm to 10 mm, taking into account a heat capacity, a cost, and a weight as well. Moreover, when a collimator for restricting an X-ray irradiation field is disposed outside the X-ray tube 10, the shield member 18 may be dispensed with.

In addition to functioning as the secondary X-ray generation portion 5, the electron passage forming member 3 has the function of intercepting an X-ray that is radiated backward (i.e., in a direction toward the electron emission source side from the target 1). It is to be noted that, because an X-ray radiated toward the electron emission source side through the electron passage 4 cannot be intercepted, a separate shield member may be provided.

A combination of the material of the target 1 and the material of the electron passage forming member 3 is important from the viewpoint of efficiently generating the secondary X-ray that is generated by the reflection electrons 12 reflected by the target 1.

Some of the electrons having collided against the target 1 lose part of incident energy and become the reflection electrons 12, which collide against the secondary X-ray generation portion 5. While a predetermined voltage is applied to the electrons directly colliding against the target 1, a voltage applied to the reflection electrons 12 is lower than that applied to the electrons incident upon the target 1 because of losing part of the incident energy. The generation of an X-ray is affected by a voltage, a current, and a material against which an electron beam collides. In order to increase efficiency in the generation of an X-ray with the reflection electrons 12, therefore, the material of the electron passage forming member 3 can be made of an element having a larger atomic number than that of the material of the target 1.

The X-ray generation apparatus having higher X-ray generation efficiency can be fabricated by selecting the combination of the material of the target 1 and the material of the electron passage forming member 3 as follows.

When the material of the target 1 is tungsten (W) or an alloy of tungsten (W) and rhenium (Re) (i.e., a W—Re alloy), the material of the electron passage forming member 3 is selected from among iridium (Ir), platinum (Pt), and gold (Au). The reason is that the electron passage forming member 3 is made of a material having a melting point as high as possible and being less susceptible to oxidation.

When the material of the target 1 is molybdenum (Mo), rhodium (Rh), or lanthanoid, the material of the electron passage forming member 3 is selected from among hafnium (Hf), tantalum (Ta), and tungsten (W). Those materials are selected for not only the reason that the electron passage forming member 3 is made of a material having a high melting point and being less susceptible to oxidation, but also the following reason.

A target made of Mo or Rh is suitably used for mammography, and characteristic X-rays (17.5 keV and 19.6 keV) of Mo are primarily used. In order to efficiently obtain those characteristic X-rays, an acceleration voltage of about 50 kV is to be applied to electrons. On the other hand, it is thought that a voltage applied to many of the reflection electrons 12 is 60% to 80% of the voltage applied to the electrons incident upon the target 1, and that they collide against the electron passage forming member 3 at an acceleration voltage of 30 kV to 40 kV. Energy of an X-ray generated at such an acceleration voltage is about 15 keV to 20 keV. Thus, the X-ray having energy at a level comparable to the energy of the characteristic X-rays of Mo is generated, and the X-ray in the desired energy range can be obtained in a larger amount.

While, in this embodiment, the electron passage forming member 3 and the secondary X-ray generation portion 5 are integrally formed as illustrated in FIG. 3, the secondary X-ray generation portion 5 made of a different material from that of the electron passage forming member 3 may be formed on the inner wall surface of the electron passage 4. For example, the material of the target 1 may be Mo, the material of the secondary X-ray generation portion 5 may be W, and the material of the electron passage forming member 3 may be copper (Cu). In that case, the thickness of the secondary X-ray generation portion 5 is preferably not less than the penetration depth of the electron beam, i.e., to be in the range of 1 μm to 100 μm.

A suitable range of the region where the secondary X-ray generation portion 5 is to be formed will be described below. The following description is made about a suitable range of a size 2R of the opening of the electron passage forming member 3 (i.e., a diameter of the electron passage 4) and a suitable range of a distance Z of the electron passage 4 (i.e., a distance over which the secondary X-ray generation portion 5 is formed, starting from the target 1) (see FIG. 3). The suitable range of the distance Z can be set in consideration of an arrival density distribution representing a density at which the reflection electrons 12 produced from the target 1 arrive at peripheral regions. According to the arrival density distribution, many arrival points of the reflection electrons 12 produced from the target 1 are present on the surface of a peripheral region within the electron passage 4 where the distance (coordinate) z from the target 1 is not larger than 2R, and about 80% of all the reflection electrons 12 exist in that peripheral region. Further, about 95% of all the reflection electrons 12 exist in a peripheral region where the distance z is not larger than 4R. Moreover, when the distance z reaches 20R, the arrival density of the reflection electrons converges to substantially zero. Accordingly, when the size of the opening of the electron passage forming member 3 is defined as 2R, the secondary X-ray generation portion 5 is preferably formed in the region where the distance z is not larger than at least 2R, and more preferably in the region where the distance z is not larger than 4R. Stated another way, the size 2R of the opening of the electron passage forming member 3 and the distance (size) Z of the electron passage 4 preferably satisfy the relationship of (2R≦Z≦20R). It is more preferable to satisfy the relationship of (4R≦Z≦20R). In the illustrated embodiment, the distance Z is equal to a thickness b of the electron passage forming member 3.

On the other hand, the opening of the electron passage forming member 3 is to be set to at least such a size that the electron beam 11 can pass through the opening. The size of the opening of the electron passage forming member 3 is not uniquely determined because the focused state of the electron beam 11 differs depending on the type of the electron emission source 6 and the type of the focusing electrode 8. However, when the shape of the opening is circular, a diameter of the circular opening is preferably 0.5 mm to 5.0 mm. Further, the thickness b of the electron passage forming member 3 is preferably 1 mm to 25 mm because the thickness b is to be 1 mm or more in order to obtain the X-ray shield effect.

The shape of the opening of the electron passage forming member 3 may be regular-polygonal instead of being circular. The reason is that a cross-section of the electron beam 11 has a circular or rectangular shape in many cases, and that distances from various regions of the target 1 against which the electron beam collides to the electron passage forming member 3 are to be evenly distributed to the utmost.

### Second Embodiment

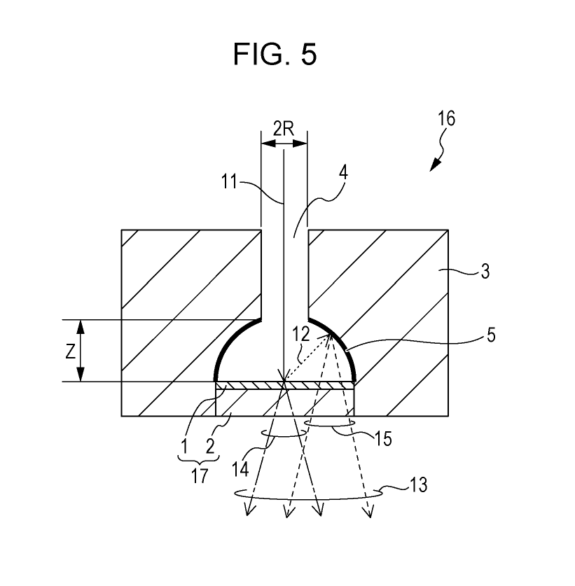

The structure of an anode 16 used in a second embodiment and an X-ray generation mechanism will be described below with reference to FIG. 4.

In the anode 16 illustrated in FIG. 4, a cross-sectional area of an electron passage 4 is continuously increased toward the target 1. Further, an inner wall surface of the electron passage 4 in a region where the cross-section area of the electron passage 4 is increased serves as a secondary X-ray generation portion 5. It is just required that at least a part of inner wall surface of the electron passage 4 in the region where the cross-section area of the electron passage 4 is increased serves as the secondary X-ray generation portion 5.

A suitable range of an angle θ formed by the secondary X-ray generation portion (surface) 5 and the target 1 is discussed below. The secondary X-ray generated from the secondary X-ray generation portion 5 is radiated in all directions. In the case of θ>90°, therefore, a large part of the generated secondary X-ray is absorbed in the secondary X-ray generation portion 5 while passing therethrough, whereas only a small part of the generated secondary X-ray is radiated to the outside. In the case of θ=90°, about a half of the generated secondary X-ray is absorbed in the secondary X-ray generation portion 5. In the case of θ<90°, a large part (at least a half or more) of the generated secondary X-ray is not absorbed in the secondary X-ray generation portion 5 and is radiated to the outside. Thus, by satisfying θ<90°, i.e., by forming the electron passage 4 in such a shape that a cross-sectional area of the electron passage 4 at its end on the side closer to the transmission-type target 1 is larger than that at its end on the side farther away from the transmission-type target 1, a rate at which the generated secondary X-ray is absorbed in the secondary X-ray generation portion 5 can be reduced and the generated secondary X-ray can be taken out in a larger amount.

Moreover, the suitable range of the angle θ can be set in consideration of dependency of the X-ray intensity on an emergent angle. Generally, because electrons accelerated to 10 kV to 200 kV penetrate into the secondary X-ray generation portion 5 about several microns without strongly depending on an incident angle, most of the secondary X-ray is also generated in a zone that is positioned several microns inward of the surface of the secondary X-ray generation portion 5. The generated secondary X-ray is radiated at various angles. When an emergent angle φ of the secondary X-ray (i.e., an angle with respect to the surface of the secondary X-ray generation portion 5) is small, a distance through which the generated secondary X-ray passes is increased. Therefore, in the range of φ<5°, for example, the X-ray intensity is abruptly reduced as the emergent angle φ decreases. Thus, given that a lower limit of the emergent angle is defined as φ₀ in consideration of the dependency of the X-ray intensity on the emergent angle, a more suitable range of the angle θ is provided by θ<90°-φ₀, taking into account the above-mentioned suitable range together. When φ₀ k is set to 5°, θ<85° is obtained. In addition, considering a lower limit value of the angle θ from the viewpoint of efficiently colliding the electrons, reflected by the target 1, against the inner wall surface of the electron passage forming member 3, the lower limit value of the angle θ is 10°, i.e., 10°<θ. Hence, an even more preferable range of the angle θ is 10°<θ<85°.

As in the first embodiment, in this second embodiment, the size 2R of the opening of the electron passage forming member 3 at the end on the target side and the distance Z over which the secondary X-ray generation portion 5 is formed, starting from the target 1, preferably satisfy the relationship of (2R≦Z≦20R). It is more preferable to satisfy the relationship of (4R≦Z≦20R).

While, in FIG. 4, the secondary X-ray generation portion 5 is formed over the entire inner wall surface of the electron passage 4 in its region where the cross-sectional area of the electron passage 4 is increased, the secondary X-ray generation portion 5 is not always required to be formed over the entire inner wall surface of the electron passage 4 in its region where the cross-sectional area of the electron passage 4 is increased. In other words, the secondary X-ray generation portion 5 is just required to be formed at least in a region of the electron passage 4, which region includes the above-mentioned range of the distance Z.

In order to provide the structure for generating the secondary X-ray by colliding the reflection electrons 12 against the secondary X-ray generation portion 5 in the electron passage 4 and for taking out the generated secondary X-ray to the outside of the X-ray tube 10, the secondary X-ray generation portion 5 and the target 1 may be arranged as follows. In one example, the secondary X-ray generation portion 5 is arranged such that it protrudes to partly cover above the surface of the target 1 against which the electrons collide. In another example, the secondary X-ray generation portion 5 and the target 1 are arranged such that the X-ray generated upon the electrons directly colliding against the target 1 and the secondary X-ray can be taken out to the outside in superimposed relation. In the latter case, the target 1 can be made of a material that reflects 20% to 60% of the colliding electrons. In the above-mentioned examples, as in the foregoing embodiment, the secondary X-ray generation portion 5 may be formed as a part of the inner wall surface of the electron passage 4, or may be formed in the electron passage 4 by using a separate member from the electron passage forming member 3.

Moreover, the target 1 and the secondary X-ray generation portion 5 are arranged such that the X-ray generated upon electrons directly colliding against the electron collision region of the target 1 and the secondary X-ray generated upon the reflection electrons colliding against the secondary X-ray generation portion 5 are superimposed with each other.

Materials and shapes of the target 1, the support base 2, and the electron passage forming member 3 used in the second embodiment are the same as those in the first embodiment.

When the material of the target 1 is tungsten (W) or an alloy of tungsten (W) and rhenium (Re), the material of the electron passage forming member 3 is selected from among iridium (Ir), platinum (Pt), and gold (Au). When the material of the target 1 is molybdenum (Mo), rhodium (Rh), or lanthanoid, the material of the electron passage forming member 3 is selected from among hafnium (Hf), tantalum (Ta), and tungsten (W).

As in the first embodiment, in the second embodiment, the secondary X-ray generation portion 5 may be formed on the inner wall surface of the electron passage 4 by using a separate member from the electron passage forming member 3. In such a case, the secondary X-ray generation portion 5 is made of a material selected from among the above-described examples of the combination. The electron passage forming member 3 may be made of a material having a high thermal conductivity, e.g., tungsten, tantalum, molybdenum, copper, silver, gold, or nickel, such that heat generated in the secondary X-ray generation portion 5 can be quickly dissipated.

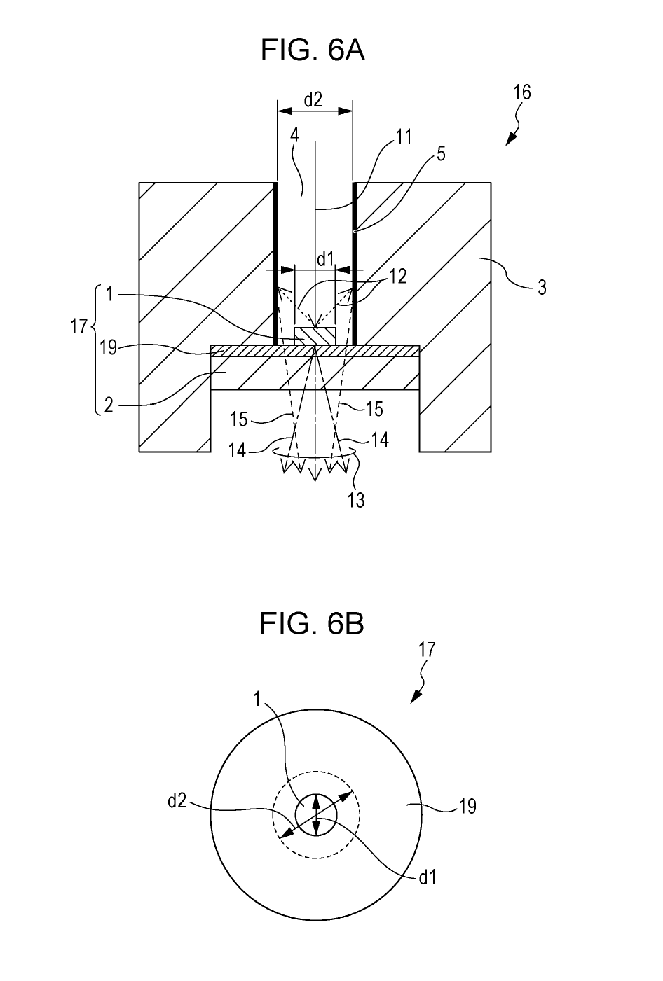

FIG. 5 illustrates a modification of the anode 16 illustrated in FIG. 4. In the modification, the electron passage 4 formed by the electron passage forming member 3 has a different shape from that in the second embodiment described above, but other common points than the shape of the electron passage 4 may be similar to those in the second embodiment described above. In the modification, a cross-sectional shape of the electron passage 4 in a direction perpendicular to the transmission-type target 1 has a circular arc shape that is convex upward when viewed on the drawing, i.e., when the side closer to the transmission-type target 1 is defined as the downward side. A similar advantageous effect to that in the above-described second embodiment can also be obtained when the anode 16 in FIG. 5 is applied to the X-ray tube 10 in FIG. 1.

### Third Embodiment

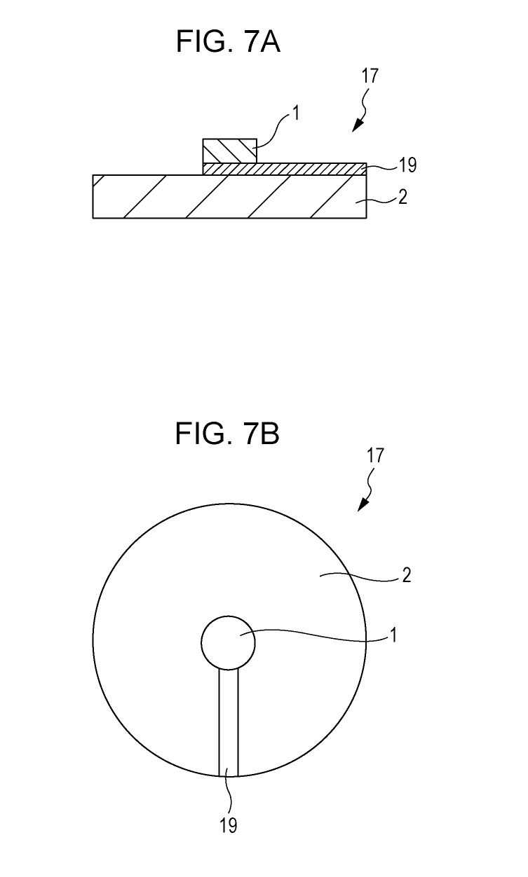

FIG. 6A is a sectional view of an anode 16 used in a third embodiment. FIG. 6B is a plan view of a target unit 17 in FIG. 6A when viewed from the electron incident side. The anode 16 is made up of the target unit 17 (including a support base 2 serving further as an X-ray transmission window, a conductive layer 19, and a target 1), and an electron passage forming member 3 including an electron passage 4. An X-ray generation apparatus according to the third embodiment includes the X-ray tube 10 illustrated in FIG. 1. The third embodiment is featured in arranging the target 1 in a central region of the support base 2 and in using the conductive layer 19. Other points may be similar to those in the first embodiment.

In the target unit 17, the conductive layer 19 is disposed on the support base 2, and the target 1 is disposed in the central region of the conductive layer 19. In FIGS. 6A and 6B, d1 denotes a diameter of the target 1, and d2 denotes an inner diameter of the electron passage 4. The target unit 17 and the electron passage forming member 3 are brazed to each other by using a brazing alloy (not illustrated), and the inside of the vacuum vessel 9 (see FIG. 1) is held vacuum. In a state where the target unit 17 and the electron passage forming member 3 are integrated with each other, a region of the conductive layer 19 outside a broken line in FIG. 6B is covered with the electron passage forming member 3.

As in the second embodiment, a secondary X-ray generation portion 5 is formed in the electron passage forming member 3. In FIG. 6A, an inner wall surface of the electron passage 4 serves as the secondary X-ray generation portion 5.

The electron passage forming member 3 includes the electron passage 4 that is opened at its both ends. Electrons enters the electron passage 4 through one end thereof (i.e., through an opening at its end on the side closer to the electron emission source 6) and collide against the target 1 disposed on the other end side of the electron passage 4 (i.e., on the side the farther away from the electron emission source 6), whereby an X-ray is generated. A region of the electron passage 4 positioned closer to the electron emission source 6 than the target 1 serves as a passage through which an electron beam 11 is introduced to an electron-beam collision region (i.e., an X-ray generation region) of the target 1. A shape of the electron passage 4 when viewed from the side including the electron emission source 6 may be optionally selected to be, e.g., circular, rectangular, or elliptic. The electron passage forming member 3 further has the function of generating a secondary X-ray with electrons, reflected upon collision against the target 1, colliding against the secondary X-ray generation portion 5. At least a part of the secondary X-ray, which is generated upon the reflection electrons 12 colliding against the secondary X-ray generation portion 5, is superimposed with an X-ray 14, which is generated upon the electrons directly colliding against the target 1. Both the superimposed X-rays are radiated to the outside of the transmission-type X-ray tube 10 after transmitting through the support base 2.

The support base 2 may be made of, e.g., diamond, silicon nitride, silicon carbide, aluminum carbide, aluminum nitride, graphite, or beryllium. Preferably, the support base 2 is made of diamond having an X-ray transmittance smaller than that of aluminum and a thermal conductivity higher than that of tungsten. A thickness of the support base 2 is preferably, though depending on materials, 0.3 mm to 2 mm.

The conductive layer 19 is disposed to prevent the target unit 17 from being charged up with electrons when the electron beam 11 collides against the target 1. To that end, the conductive layer 19 may be made of any material having electrical conductivity. Therefore, various metal materials, carbides, oxides, etc. may be optionally used as the conductive layer 19. The conductive layer 19 is formed on the support base 2 by sputtering or vapor deposition. When the support base 2 is made of a conductor such as graphite or beryllium, or when it is made of a material capable of providing electrical conductivity with mixing of an additive to an insulator, the conductive layer 19 may be dispensed with. Usually, however, because a commercially available insulator, such as diamond, has no electrical conductivity, the conductive layer 19 is to be disposed. Moreover, when the conductive layer 19 is disposed, a voltage can be supplied to the target 1 through the conductive layer 19.

When the conductive layer 19 aims just to prevent the target unit 17 from being charged up with electrons, no restrictions are imposed on a material type and a thickness of the conductive layer 19 on condition that the conductive layer 19 has electrical conductivity. In this embodiment, however, the conductive layer 19 is further given with the function of taking out the secondary X-ray generated from the secondary X-ray generation portion 5 to the outside. Accordingly, influences of the material type and the thickness of the conductive layer 19 are also significant as described later.

Materials and shapes of the target 1 and the electron passage forming member 3 used in the third embodiment are the same as those in the first embodiment.

When the material of the target 1 is tungsten (W) or an alloy of tungsten (W) and rhenium (Re), the material of the electron passage forming member 3 is selected from among iridium (Ir), platinum (Pt), and gold (Au). When the material of the target 1 is molybdenum (Mo), rhodium (Rh), or lanthanoid, the material of the electron passage forming member 3 is selected from among hafnium (Hf), tantalum (Ta), and tungsten (W).

As in the first embodiment, in the third embodiment, the secondary X-ray generation portion 5 may be formed on the surface of the electron passage forming member 3 by using a material different from that of the electron passage forming member 3.

Moreover, as in the first embodiment, in the third embodiment, the size 2R of the opening of the electron passage forming member 3 (i.e., the inner diameter d2 of the electron passage 4) and the distance Z over which the secondary X-ray generation portion 5 is formed, starting from the target 1, preferably satisfy the relationship of (2R≦Z≦20R). It is more preferable to satisfy the relationship of (4R≦Z≦20R).

The electron beam 11 produced from the electron emission source 6 collides against the target 1 through the electron passage 4 formed by the electron passage forming member 3, thereby generating an X-ray from the target 1. A part of the generated X-ray is attenuated with absorption by the target 1 itself and is further attenuated with absorption by the support base 2 that also serves as the X-ray transmission window. However, an extent of those attenuations is small and is practically allowable. The diameter dl of the target 1 can be almost equal to a diameter of a cross-section of the electron beam 11.

On the other hand, some of the electrons having collided against the target 1 are reflected and become reflection electrons, which collide against the secondary X-ray generation portion 5, thereby generating the secondary X-ray from the secondary X-ray generation portion 5.

When the secondary X-ray transmits through the target unit 17, one part of the secondary X-ray transmits through two layers, i.e., the conductive layer 19 and the support base 2, and the other part transmits through three layers, i.e., the target 1, the conductive layer 19, and the support base 2. The material and the thickness of the target 1 are to be optimized depending on conditions in use because the target 1 is required to have the material and the thickness adapted for efficiently generating the X-ray upon the collision of electrons. On the other hand, the conductive layer 19 hardly generates an X-ray upon the collision of electrons. Accordingly, for the conductive layer 19, it is just required to consider electrical conductivity, i.e., the intrinsic function of the conductive layer 19, and X-ray transmissivity. It is however to be noted that, because energy of the secondary X-ray is lower than that of the X-ray radiated from the target 1, absorption of the X-ray by the conductive layer 19 may become too large to sufficiently take out the secondary X-ray in some cases when the material and the thickness of the conductive layer 19 are the same as those of the target 1.

As a material used for the conductive layer 19 and providing high X-ray transmissivity, a light element is suitable and, for example, aluminum, titanium, silicon nitride, silicon, graphite, etc. may be optionally used. When such an element having a mass lighter than that of the target 1 is used, the thickness of the conductive layer 19 is preferably 0.1 nm to 1 μm. The material of the conductive layer 19 may be the same as that of the target 1. When the material of the conductive layer 19 is the same as that of the target 1, the thickness of the conductive layer 19 is just required to be thin to such an extent as not practically impeding transmission of the X-ray therethrough. Even a metal material having an atomic number of 26 or more and being usually employed for the target 1 can also be used for the conductive layer 19 on condition that its thickness is sufficiently thin and high X-ray transmissivity is obtained. For example, in trying to use tungsten as the material of the conductive layer 19, when the thickness of the conductive layer 19 is 0.1 nm to 0.2 μm, tungsten can be used as in the case of a light element because the X-ray is just slightly intercepted by the conductive layer 19 having such a thickness.

While, in the third embodiment, the conductive layer 19 is disposed on the support base 2 and the target 1 is disposed on the conductive layer 19, the order of stacking those members is not limited to that one. The conductive layer 19 may be disposed on the target 1.

When the target 1 is disposed on the conductive layer 19, the thickness of the conductive layer 19 in its region covered with the target 1 is preferably set to 0.1 nm to 0.1 μm. The reason is that the setting to such a thickness range ensures good linearity and output stability during the radiation of the X-ray. Additionally, the thickness of the conductive layer 19 other than the region covered with the target 1 may be set without being limited to the above-mentioned range. Moreover, when the conductive layer 19 and the target 1 are made of the same material, the thickness of the conductive layer 19 in its region covered with the target 1 may be set without being limited to the above-mentioned range.

When the conductive layer 19 is disposed on the target 1, the thickness of the conductive layer 19 in its region covering the target 1 is preferably set to 0.1 nm to 0.1 μm. The reason is that, with the setting to such a thickness range, an amount of an X-ray generated upon electrons directly colliding against the conductive layer 19 is held within an allowable range. Additionally, the thickness of the conductive layer 19 other than the region covering the target 1 may be set without being limited to the above-mentioned range because electrons do not directly collide against the conductive layer 19 in the relevant region. Moreover, when the conductive layer 19 and the target 1 are made of the same material, the thickness of the conductive layer 19 in its region covering the target 1 may be set without being limited to the above-mentioned range. In the structure described above, the transmittance in a central region of the support base 2, which is covered with the target 1, for the X-ray (i.e., the secondary X-ray) generated upon the electrons, reflected by the target 1, colliding against the inner wall surface of the electron passage 4 is 30% to 70% of that in a peripheral region of the support base 2, which is not covered with the target 1.

Thus, according to the third embodiment, the secondary X-ray can be generated from the inner wall surface of the electron passage 4, and the peripheral region of the support base 2, which is not covered with the target 1, is covered with the conductive layer 19. Hence, the peripheral region of the support base 2 has a higher transmittance for the secondary X-ray than the central region thereof.

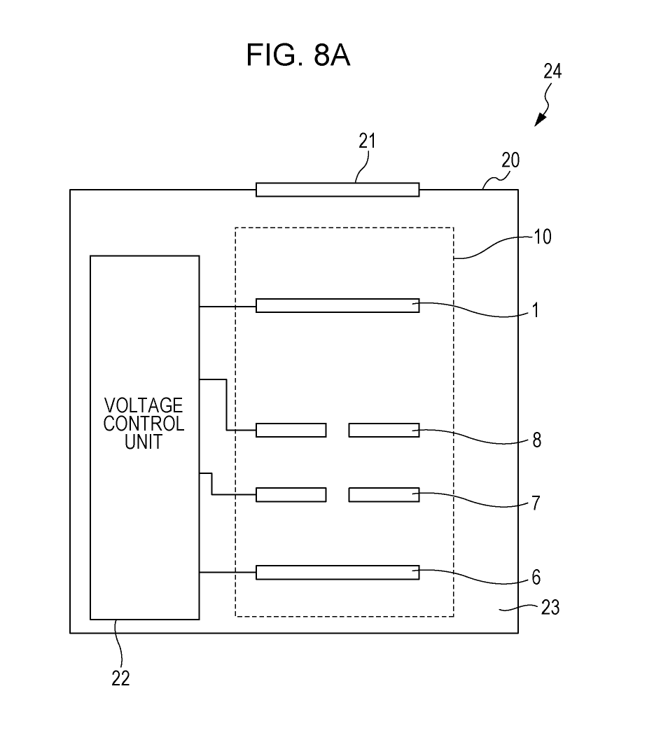

FIGS. 7A and 7B illustrate a modification of the target unit 17 illustrated in FIGS. 6A and 6B. FIG. 7A is a sectional view, and FIG. 7B is a plan view of the target unit 17 when viewed from the electron incident side. The target unit 17 according to this modification may have the same structure as that in the above-described third embodiment except for the shape of the conductive layer 19. The conductive layer 19 is disposed so as to position in a central region of the support base 2 and to extend from the central region to a peripheral edge of the support base 2 in its partial region other than the central region. Further, the target 1 is disposed on the conductive layer 19 that is positioned in the central region of the support base 2. Thus, in a peripheral region of the support base 2 not covered with the target 1, the conductive layer 19 is disposed in a part of the peripheral region, and the support base 2 is exposed in the other part of the peripheral region. The conductive layer 19 is connected to the target 1.

In the third embodiment, the shape of the electron passage 4 may be modified as illustrated in FIGS. 4 and 5.

With any of the above-described embodiments, the secondary X-ray generated with the reflection electrons 12 reflected by the target 1 can also be efficiently taken out to the outside in addition to the X-ray 14 generated from the target 1. As a result, the X-ray generation efficiency can be increased.

### Fourth Embodiment

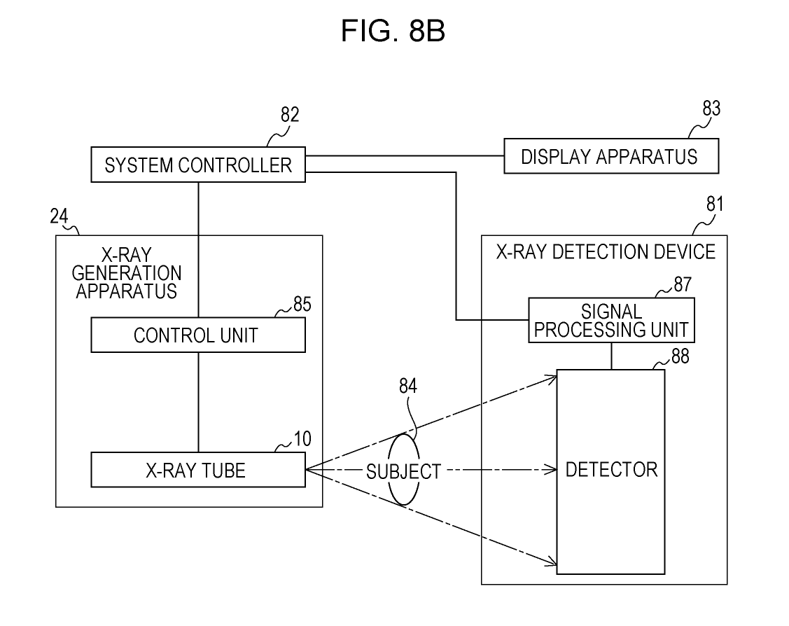

FIGS. 8A and 8B are block diagrams illustrating respectively an X-ray generation apparatus 24 and an X-ray radiographic apparatus according to the present invention.

In the X-ray generation apparatus 24 illustrated in FIG. 8A, the X-ray tube 10 according to one of the above-described first to third embodiments is disposed inside an envelope 20. The envelope 20 includes an X-ray taking-out window 21. An X-ray emitted from the X-ray tube 10 transmits through the X-ray taking-out window 21, and it is radiated to the outside of the X-ray generation apparatus 24.

An insulating medium 23 may be filled in an inner empty space of the envelope 20 within which the X-ray tube 10 is disposed. An example of the insulating medium 23 is electrical insulating oil that serves as not only an insulating medium, but also a cooling medium to cool the X-ray tube 10. The electrical insulating oil can be provided as, e.g., mineral oil or silicone oil. Another example usable as the insulating medium 23 is a fluorine-based electrical insulating liquid.

A voltage control unit 22 made up of a circuit board, an insulating transformer, etc. may be disposed inside the envelope 20. The voltage control unit 22 can control the generation of the X-ray by applying a voltage signal to the X-ray tube 10.

Further, as illustrated in FIG. 8B, a system controller 82 controls the X-ray generation apparatus 24 and an X-ray detection device 81 in a cooperating manner. A control unit 85 in the X-ray generation apparatus 24 outputs various control signals to the X-ray tube 10 under control of the system controller 82. A radiation state of the X-ray radiated from the X-ray tube 10 (i.e., the X-ray generation apparatus 24) is controlled in accordance with the control signals. The X-ray radiated from the X-ray generation apparatus 24 transmits through a subject (specimen) 84, and it is detected by a detector 88. The detector 88 converts the detected X-ray to an image signal and outputs the image signal to a signal processing unit 87. The signal processing unit 87 executes predetermined signal processing on the image signal and outputs the processed image signal to the system controller 82 under control of the system controller 82. The system controller 82 outputs, to a display apparatus 83, a display signal for displaying an image in accordance with the processed image signal. The display apparatus 83 displays an image in accordance with the display signal, as a radiographic image of the subject 84, on a screen.

According to the fourth embodiment, since the X-ray generation apparatus having higher X-ray generation efficiency is used, an X-ray radiographic apparatus having a smaller size and higher resolution can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-189223, filed Aug. 31, 2011, which is hereby incorporated by reference herein in its entirety.

### REFERENCE SIGNS LIST

1: transmission-type target (target)

2: support base

3: electron passage forming member

4: electron passage

5: secondary X-ray generation portion

10: X-ray tube

11: electron beam

12: reflection electron

13 to 15: X-rays

16: anode

17: target unit

18: shield member

19: conductive layer

24: X-ray generation apparatus

1. An X-ray generation apparatus of transmission type including an electron passage formed in an electron passage forming member, and generating an X-ray by colliding electrons having passed through the electron passage against a target,
wherein the electron passage includes a secondary X-ray generation portion that generates an X-ray with collision of electrons reflected by the target against the secondary X-ray generation portion,
the secondary X-ray generation portion and the target are arranged such that the X-ray generated with direct collision of the electrons against the target and the X-ray generated with the collision of the electrons reflected by the target against the secondary X-ray generation portion are both radiated to an outside, and
an atomic number of a material of the electron passage forming member is larger than an atomic number of a material of the target.

2. The X-ray generation apparatus according to claim 1, wherein the material of the target is W or a W—Re alloy, and the material of the electron passage forming member is one of Ir, Pt and Au.

3. The X-ray generation apparatus according to claim 1, wherein the material of the target is Mo or Rh, and the material of the electron passage forming member is one of Hf, Ta and W.

4. The X-ray generation apparatus according to claim 1, wherein the material of the target is lanthanoid, and the material of the electron passage forming member is one of Hf, Ta and W.

5. The X-ray generation apparatus according to claim 1, wherein the secondary X-ray generation portion protrudes to cover above a surface of the target against which the electrons collide.

6. The X-ray generation apparatus according to claim 5, wherein a cross-sectional area of the electron passage at least at an end thereof on a side closer to the target is increased in comparison with a cross-sectional area of the electron passage on a side farther away from the target, and at least a part of an inner wall surface of a region of the electron passage where the cross-sectional area thereof is increased serves as the secondary X-ray generation portion.

7. The X-ray generation apparatus according to claim 1, wherein the target reflects 20% to 60% of the colliding electrons.

8. The X-ray generation apparatus according to claim 1, wherein the target is disposed in a central region of a support base, and
at least a part of a peripheral region of the support base, which region is not covered with the target, has a transmittance higher than that of the central region of the support base, which central region is covered with the target, for the X-ray generated from the secondary X-ray generation portion.

9. The X-ray generation apparatus according to claim 8, wherein a conductive layer connected to the target is disposed at least in a part of the peripheral region of the support base, which region is not covered with the target.

10. The X-ray generation apparatus according to claim 9, wherein a thickness of the conductive layer is smaller than a thickness of the target.

11. An X-ray radiographic apparatus comprising:
the X-ray generation apparatus according to claim 1;
an X-ray detection device configured to detect an X-ray having been radiated from the X-ray generation apparatus and having transmitted through a subject; and
a controller configured to control the X-ray generation apparatus and the X-ray detection apparatus in a cooperating manner.
